(19) United States
(12) Patent Application Publication
(10) Pub. No.: US 2012/0003569 A1
(43) Pub. Date: Jan. 5, 2012

(54) METHOD OF FORMING A TERNARY ALLOY CATALYST FOR FUEL CELL

(76) Inventors: Tetsuo Kawamura, South Glastonbury, CT (US); Lesia V. Protsailo, Bolton, CT (US)

(21) Appl. No.: 13/255,961

(22) PCT Filed: Mar. 18, 2009
(86) PCT No.: PCT/US09/37462

§ 371 Date: Sep. 12, 2011

(51) Int. Cl. H01M 4/92; H01M 8/02; B01J 21/18; B01J 37/02; B82Y 30/00

(52) U.S. Cl. 429/524; 502/185; 502/184; 977/948

(57) ABSTRACT

A method of forming a supported catalyst for a fuel cell includes depositing platinum onto a carbon support material, depositing a first alloy metal onto the carbon support material following the deposition of the platinum, and depositing a second alloy metal onto the carbon support material following the deposition of the first alloy metal. The first alloy metal is selected from iridium, rhodium, palladium, and combinations thereof, and the second alloy metal includes a first or second row transition metal.

### BACKGROUND OF THE DISCLOSURE

This invention relates to catalytic alloys and, more particularly, to a stable, high activity ternary alloy catalyst for use in fuel cells.

Fuel cells are commonly known and used for generating electric current. For example, a fuel cell typically includes an anode catalyst, a cathode catalyst, and an electrolyte between the anode catalyst and the cathode catalyst for generating an electric current in a known electrochemical reaction between a fuel and an oxidant.

One problem associated with fuel cells is the operational efficiency of the catalysts. For example, chemical activity at the cathode catalyst is one parameter that controls the efficiency. An indication of the chemical activity is the rate of electrochemical reduction of the oxidant at the cathode catalyst. Platinum has been conventionally used for the cathode catalyst. However, greater activity than pure platinum catalysts is desired. Also, above certain voltages, platinum has limited stability in the elevated temperature environment of the fuel cell. For instance, load cycles during fuel cell operation may cause degradation of the chemical activity over time from platinum dissolution and reduction in electrochemical surface area.

One solution has been alloying the platinum with certain transitional metals and other noble metals to increase the catalytic activity. For instance, platinum in ternary alloys with iridium and another metal has proved to be somewhat effective.

### SUMMARY OF THE DISCLOSURE

An example method of forming a supported catalyst for a fuel cell includes depositing platinum onto a carbon support material, depositing a first alloy metal onto the carbon support material following the deposition of the platinum, and depositing a second alloy metal onto the carbon support material following the deposition of the first alloy metal. The first alloy metal is selected from iridium, rhodium, palladium and combinations thereof, and the second alloy metal includes a first or second row transitional metal.

In another aspect, a fuel cell includes a carbon support material and a catalytic alloy disposed as particles on the carbon support material. The catalytic alloy has a crystallographic lattice constant of about 3.78-3.83 Angstroms and a composition Ptᵢ-M¹ⱼ-M²ₖ, where 40≦i≦60 mol %, 5≦j≦30 mol %, 20≦k≦50 mol %, M¹ is selected from a group consisting of iridium, rhodium, palladium, and combinations thereof, and M² is selected from the group consisting of titanium, manganese, cobalt, vanadium, chromium, nickel, copper, zirconium, iron, and combinations thereof. The particles may have an average particle size of about 30-90 Angstroms.

### BRIEF DESCRIPTION OF THE DRAWINGS

The various features and advantages of the disclosed examples will become apparent to those skilled in the art from the following detailed description. The drawings that accompany the detailed description can be briefly described as follows.

FIG. 1 illustrates an example fuel cell.

FIG. 2 illustrates an example of a cathode catalyst, including a supported catalyst.

FIG. 3 illustrates an example method for forming a supported catalyst.

### DETAILED DESCRIPTION OF THE PREFERRED EMBODIMENT

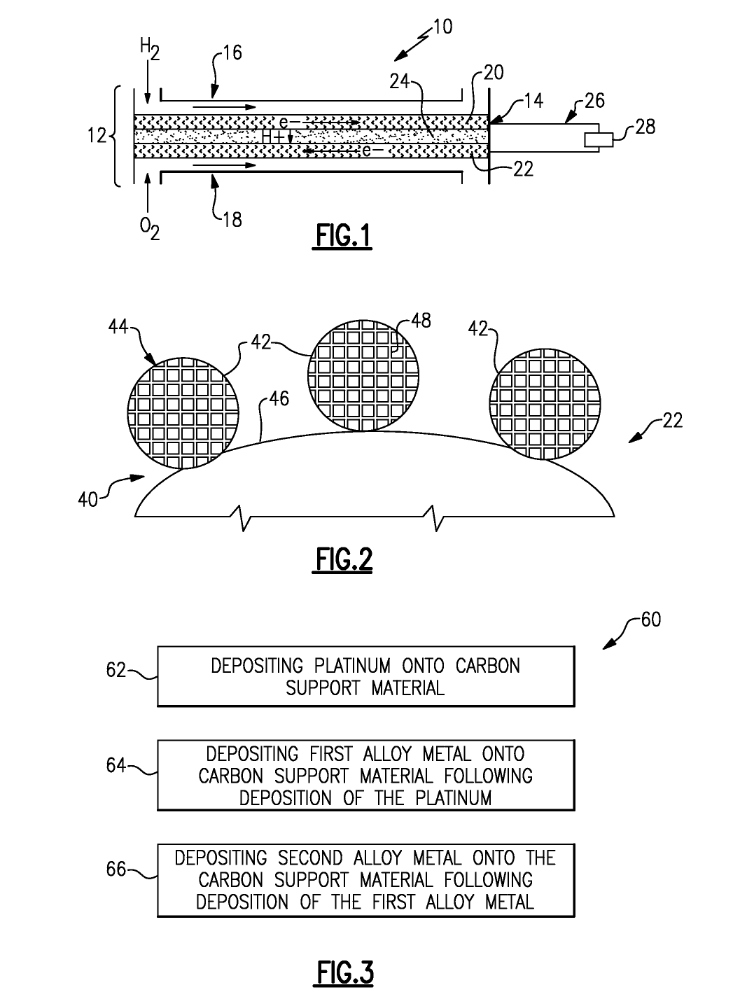

FIG. 1 schematically illustrates selected portions of an example fuel cell 10. In this example, a single fuel cell unit 12 is shown; however, it is to be understood that multiple fuel cell units 12 may be stacked in a known manner in the fuel cell 10 to generate a desired amount of electric power. It is also to be understood that this disclosure is not limited to the arrangement of the example fuel cell 10, and the concepts disclosed herein may be applied to other fuel cell arrangements.

In the illustrated example, the fuel cell 10 includes an electrode assembly 14 located between an anode interconnect 16 and a cathode interconnect 18. For instance, the anode interconnect 16 may deliver fuel, such as hydrogen gas, to the electrode assembly 14. Likewise, the cathode interconnect 18 may deliver an oxidant, such as oxygen gas (air), to the electrode assembly 14. In this regard, the anode interconnect 16 and the cathode interconnect 18 are not limited to any particular structure, but may include channels or the like for delivering the reactant gases to the electrode assembly 14.

The electrode assembly 14 includes an anode catalyst 20, a cathode catalyst 22, and an electrolyte 24 located between the anode catalyst 20 and the cathode catalyst 22. For example, the electrolyte 24 may be any suitable type of electrolyte for conducting ions between the anode catalyst 20 and the cathode catalyst 22 in the electrochemical reaction to generate the electric current. In a few non-limiting examples, the electrolyte 24 may be phosphoric acid, a polymer electrolyte membrane, a solid oxide electrolyte, or other type of electrolyte.

As is generally known, the hydrogen at the anode catalyst 20 disassociates into protons that are conducted through the electrolyte 24 to the cathode catalyst 22 and electrons that flow through an external circuit 26 to power a load 28, for example. The electrons from the external circuit 26 combine with the protons and oxygen at the cathode catalyst 22 to form a water byproduct.

Referring to FIG. 2, at least the cathode catalyst 22, and optionally also the anode catalyst 20, is a supported catalyst 40. The illustrated supported catalyst 40 is not necessarily shown to scale. The supported catalyst 40 includes catalytic alloy 42 in the form of particles 44 disposed on a carbon support material 46. For instance, the carbon support material may be carbon black or other type of carbon material. A combined weight percentage of the catalytic alloy 42 may be about 15-70 wt % of a total weight of the supported catalyst 40.

The catalytic alloy 42 of the illustrated example is highly active and stable under typical fuel cell operating conditions. For instance, the catalytic alloy 42 includes a composition of platinum, a first alloy metal selected from iridium, rhodium, palladium and combinations thereof, and a second alloy metal including a first or second row transitional metal element. In a few examples, the first or second row transitional metal element may include titanium, manganese, cobalt, vanadium, chromium, nickel, copper, zirconium, iron, and combinations thereof. The composition may be Ptᵢ-M¹ⱼ-M²ₖ, where 40≦i≦60 mol %, 5≦j≦30 mol %, 20≦k≦50 mol %, M¹ is selected from iridium, rhodium, palladium and combinations thereof, and M² is selected from titanium, manganese, cobalt, vanadium, chromium, nickel, copper, zirconium, iron, and combinations thereof. In the given example, the particles 44 have an average particle size of about 30-90 Angstroms (300-900 nanometers) and a crystallographic lattice constant 48 of about 3.78-3.83 Angstroms (37.8-38.3 nanometers). In the illustration, an atomic lattice crystal structure is represented by a grid, with atoms of the composition being at the corners of the grid. In some examples, the crystallographic lattice constant 48 may be about 3.74-3.86 Angstroms (37.4-38.6 nanometers) and the average particle size may be less than 60 Angstroms (600 nanometers). In a further example, the M² metal is cobalt, which may provide the greatest influence on the crystallographic lattice constant 48, activity, and stability of the catalytic alloy 42 relative to the other second alloy metals.

The disclosed supported catalyst 40 may be formed according to the method 60 illustrated in FIG. 3. In this example, the method 60 includes a step 62 of depositing the platinum onto the carbon support material 46, a step 64 of depositing the first alloy metal onto the carbon support material 46 following the deposition of the platinum, and a step 66 of depositing the second alloy metal onto the carbon support material 46 following the deposition of the first alloy metal.

The deposition of the platinum, the first alloy metal, and the second alloy metal onto the carbon support material 46 is not necessarily limited to any specific type of deposition process. However, in a few examples, the platinum, the first alloy metal, and the second alloy metal are prepared in separate aqueous solutions from metal salts. The carbon support material 46 is then sequentially exposed to the aqueous solutions. Each solution is reduced using a reducing agent to precipitate the respective platinum, first alloy metal, or second alloy metal onto the carbon support material 46. For instance, the reducing agent may be hydrazine, sodium borohydride, formic acid, or formaldehyde, although there may also be other effective reducing agents. Alternatively, vacuum reduction may be used to evaporate the water from each of the aqueous solutions and thereby precipitate the respective platinum, first alloy metal, or second alloy metal onto the carbon support material 46. The concentrations of the metals in the aqueous solutions may be selected based on the desired amount of the metal to be deposited.

The precipitated platinum, first alloy metal, and second alloy metal are typically in the form of an intermediate compound, such as a salt, organometallic complex, or other compound. The intermediate compound may then be calcined at a predetermined temperature for a predetermined amount of time, such as 600-1000° C. (1112-1832° F.) for 0.5 to 5 hours, in an inert gas (e.g., nitrogen) to convert the intermediate compound to a metallic form. The calcining also alloys the metals together into the high surface area particles 44 illustrated in FIG. 2.

The following is an additional example of method 60 for preparing the supported catalyst 40.

### Example 1

The following steps were used to prepare the supported catalyst 40 having the catalytic alloy 42 with a composition of Ptᵢ-M¹ⱼ-M²ₖ, where i=50 mol %, j=25 mol %, and k=25 mol %, M¹ is iridium, and M² is cobalt. Given this description, one of ordinary skill in the art will recognize modifications of this example for other compositions to meet their particular needs.

High surface area carbon support such as KB EC 300J has been dispersed in water with sodium bicarbonate and heated to boiling. Chloroplatanic acid (CPA) was added as a source of platinum and diluted solution of formaldehyde was used as reducing agent. After carbon supported platinum catalyst dispersion has been filtered and powder dried, it was redispersed in water and iridium was added in form of iridium chloride. Formaldehyde was added to hot solution for reduction of iridium. The pH of the solution is maintained between 5.5 and 6.0 during this step either by using ammonium hydroxide or acetic acid. After reduction was complete solid catalyst was collected, rinsed with water and remaining platinum was added in form of CPA. After final reduction step, dry precursor of PtIr/C was collected, dried and sieved. Last step of synthesis included dispersion of PtIr/C in water and addition of cobalt nitrate. After mixture is dried in vacuum, precursor is heat treated in tube furnace to 923° C. to form PtIrCo/C catalyst.

The processing method 60 establishes the high chemical activity and stability of the example catalytic alloy 42. For instance, the order of the deposition of the platinum, the first alloy metal, and the second alloy metal onto the carbon support material 46 influences the activity and stability of the supported catalyst 40. For example, initially depositing the platinum onto the carbon support material 46 highly disperses platinum over the surfaces of the carbon support material 46. The initially deposited platinum provides a foundation for the deposition of the first alloy metal and thereby facilitates the reduction of the first alloy metal to promote high dispersion of the first alloy metal over the carbon support material 46. Methods utilizing co-deposition of platinum and iridium therefore inherently cannot achieve such an effect because there would be no pre-deposited platinum to facilitate the deposition and dispersion of the iridium. The degree of dispersion of the platinum and the first alloy metal at least partially controls the average particle size of the particles 44 and the degree of alloying between the platinum, first alloy metal, and first alloy metal during the calcining. Thus, higher degrees of dispersion achieve smaller average particles sizes and high activity and stability.

In a further example of the method 60, a portion of a total amount of the platinum may first be deposited onto the carbon support material 46 before the deposition of the first alloy metal and the second alloy metal. A remainder of the total amount of the platinum may then be deposited onto the carbon support material 46 after the deposition of the first alloy metal and before the deposition of the second alloy metal. Initially depositing only a portion of the platinum further promotes dispersion among the platinum and the first alloy metal to facilitate achieving smaller average particles sizes and high activity and stability.

In one example, about 25% of the total amount of the platinum is initially deposited onto the carbon support material 46 before the deposition of the first alloy metal. The remainder the total amount of the platinum is then deposited onto the carbon support material 46 after the deposition of the first alloy metal. For instance, if the platinum accounts for about 35-45 wt % of the total weight of the supported catalyst 40, about 8.75 wt % (or 0.25×35 wt %) to 11.25 wt % (or 0.25×45 wt %) may be initially deposited onto the carbon support material 46 before the deposition of the first alloy metal, with the remaining amount of about 26.25 wt % (or 0.75×35 wt %) to 33.75 wt % (or 0.75×45 wt %) being deposited after the deposition of the first alloy metal. Forming the supported catalyst 40 in this manner may be used to establish an average particle size of about 54 Angstroms (540 nanometers) or less and establish a crystallographic lattice constant 48 of about 3.74-3.86 Angstroms (37.4-38.6 nanometers).

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from the essence of this disclosure. The scope of legal protection given to this disclosure can be determined by studying the following claims.

What is claimed is:

1. A method of forming a supported catalyst for a fuel cell, comprising:
depositing platinum onto a carbon support material;
following deposition of the platinum, depositing a first alloy metal onto the carbon support material, the first alloy metal being selected from a group consisting of iridium, rhodium, palladium, and combinations thereof; and
following deposition of the first alloy metal, depositing a second alloy metal that is different than the first alloy metal onto the carbon support material to form a supported catalyst comprising a catalytic alloy of the platinum, the first alloy metal, and the second alloy metal disposed on the carbon support material, the second alloy metal including a first or second row transitional metal element.

2. The method as recited in claim 1, wherein the first or second row transitional metal element is selected from a group consisting of titanium, manganese, cobalt, vanadium, chromium, nickel, copper, zirconium, iron, and combinations thereof.

3. The method as recited in claim 1, wherein depositing the platinum includes depositing a portion of a total amount of platinum on the carbon support material, followed by depositing the first alloy metal, followed by depositing a remainder of the total amount of the platinum on the carbon support material, followed by depositing the second alloy metal.

4. The method as recited in claim 1, wherein depositing the platinum includes depositing about 25% of a total amount of platinum on the carbon support material, followed by depositing the first alloy metal, followed by depositing a remainder of the total amount of the platinum on the carbon support material.

5. The method as recited in claim 1, wherein depositing the platinum, depositing the first alloy metal, and depositing the second alloy metal include reducing the respective platinum, first alloy metal, and second alloy metal from an ionic state using a reducing agent selected from the group consisting of hydrazine, sodium borohydrate, formic acid, and formaldehyde.

6. The method as recited in claim 1, wherein depositing the platinum, depositing the first alloy metal, and depositing the second alloy metal include reducing the respective platinum, first alloy metal, and second alloy metal from an ionic state using vacuum reduction.

7. The method as recited in claim 6 or 7, further comprising calcining the deposited platinum, first alloy metal, and second alloy metal at a temperature of 600-1000° C. (1112-1832° F.) for a predetermined amount of time.

8. The method as recited in claim 1, further comprising depositing 20-60 mol % of the platinum, depositing 5-30 mol % of the first alloy metal, and depositing 20-50 mol % of the second alloy metal to form the catalytic alloy.

9. The method as recited in claim 1, wherein the first alloy metal is the iridium and the second alloy metal is the cobalt.

10. The method as recited in claim 1, further comprising establishing a combined weight percentage of the platinum, the first alloy metal, and the second alloy metal that is 20-60 wt % of a total weight of the supported catalyst.

11. The method as recited in claim 1, further comprising establishing an average particle size of the catalytic alloy that is about 30-90 Angstroms (300-900 nanometers).

12. The method as recited in claim 1, further comprising establishing an average particle size of the catalytic alloy that is less than 60 Angstroms (600 nanometers).

13. The method as recited in claim 1, further comprising establishing a crystallographic lattice constant of the catalytic alloy that is about 3.78-3.83 Angstroms (37.8-38.3 nanometers).

14. The method as recited in claim 1, further comprising establishing a crystallographic lattice constant of the catalytic alloy that is about 3.74-3.86 Angstroms (37.4-38.6 nanometers).

15. A fuel cell having an electrolyte disposed between an anode electrode and a cathode electrode, wherein the cathode electrode is the supported catalyst formed according to the method recited in claim 1.

16. A fuel cell comprising:
a carbon support material; and
a catalytic alloy disposed as particles on the carbon support material, the catalytic alloy having a crystallographic lattice constant of about 3.78-3.83 Angstroms (37.8-38.3 nanometers) and a composition Ptᵢ-M¹ⱼ-M²ₖ, where 40≦i≦60 mol %, 5≦j≦30 mol %, 20≦k≦50 mol %, M¹ is selected from a group consisting of iridium, rhodium, palladium, and combinations thereof, and M² is selected from the group consisting of titanium, manganese, cobalt, vanadium, chromium, nickel, copper, zirconium, iron, and combinations thereof, and the particles have an average particle size of about 30-90 Angstroms (300-900 nanometers).

17. The fuel cell as recited in claim 15, wherein the average particle size of about 30-90 Angstroms (300-900 nanometers) and the crystallographic lattice constant of about 3.78-3.83 Angstroms (37.8-38.3) are established by depositing the platinum onto the carbon support material, depositing the M¹ onto the carbon support material following the deposition of the platinum, and depositing the M² onto the carbon support material following the deposition of the Mⁱ.
